(19) United States
(12) Patent Application Publication
(10) Pub. No.: US 2026/0301735 A1
(43) Pub. Date: Oct. 1, 2026

(54) SPEECH INPUT METHOD, SPEECH INPUT APPARATUS, AND COMPUTER-READABLE STORAGE MEDIUM

(71) Applicant: Beijing Zitiao Network Technology Co., Ltd., Beijing (CN)

(72) Inventors: Jiayi ZHAO, Beijing (CN); Ziyang ZHENG, Beijing (CN)

(21) Appl. No.: 19/538,416

(22) Filed: Feb. 12, 2026

(30) Foreign Application Priority Data
Mar. 27, 2025 (CN) 202510376618.6

(51) Int. Cl. G10L 15/18; G10L 15/22

(52) U.S. Cl. CPC G10L 15/1815; G10L 2015/223

(57) ABSTRACT

The present disclosure relates to the field of computer technologies, and in particular, to a speech input method, a speech input apparatus, and a computer-readable storage medium. The speech input method includes: receiving, from an input box of a conversation between a user and an agent, speech data input by the user; and determining an input text corresponding to the speech data according to the speech data and contextual data, where the contextual data includes at least one of: text data input by the user in the input box before the speech data is input, or a historical conversation between the user and the agent.

### CROSS-REFERENCE TO RELATED APPLICATIONS

This application is based on Chinese application No. 202510376618.6, filed on Mar. 27, 2025 and claims its priority. The disclosure of the Chinese application is hereby incorporated into this application as a whole.

### TECHNICAL FIELD

The present disclosure relates to the field of computer technologies, and in particular, to a speech input method, a speech input apparatus, a computer-readable storage medium, and a computer program product.

### BACKGROUND

With the development of computer technologies, speech input technologies provide people with an efficient and convenient interaction manner, and users may quickly complete text input through speech, thereby improving life efficiency.

However, in the related art, in a complex language environment, if there are a relatively large number of words corresponding to a pronunciation of a user, recognition on content of speech input by the user may not be sufficiently accurate, and thus needs to be further improved.

### SUMMARY

In view of this, embodiments of the present disclosure provide a speech input method, a speech input apparatus, a computer-readable storage medium, and a computer program product, which are capable of combining contextual data related to a user with speech data input by the user, to determine a corresponding text, thereby improving accuracy of speech input.

According to some embodiments of the present disclosure, a speech input method is provided, including: receiving, from an input box of a conversation between a user and an agent, speech data input by the user; and determining an input text corresponding to the speech data according to the speech data and contextual data, where the contextual data includes at least one of text data input by the user in the input box before the speech data is input, or a historical conversation between the user and the agent.

According to some other embodiments of the present disclosure, a speech input apparatus is provided, including: a receiving module, configured to receive, from an input box of a conversation between a user and an agent, speech data input by the user; and a determination module, configured to determine a target input text corresponding to the speech data according to the speech data and contextual information data of the user, as an input of the user, where the contextual data includes at least one of text data input by the user in the input box before the speech data is input, or a historical conversation between the user and the agent.

According to some embodiments of the present disclosure, a speech input apparatus is provided, including: at least one memory; and at least one processor coupled to the at least one memory, the at least one processor configured to, based on instructions stored in the at least one memory, execute the speech input method according to any embodiment of the present disclosure.

According to some embodiments of the present disclosure, a computer-readable storage medium is provided, having a computer program stored thereon, where when the program is executed by a processor, the speech input method according to any embodiment of the present disclosure is implemented.

According to some embodiments of the present disclosure, a computer program product is provided, which, when running on a computer, causes the computer to implement the speech input method according to any embodiment of the present disclosure.

Other features, aspects, and advantages of the present disclosure become apparent with reference to the following detailed description of the exemplary embodiments of the present disclosure.

### BRIEF DESCRIPTION OF THE DRAWINGS

Reference is made to the drawings to describe the embodiments of the present disclosure. It should be understood that the drawings in the following description relate to only some embodiments of the present disclosure, rather than limiting the present disclosure. In the drawings:

FIG. 1 is a schematic flowchart of a speech input method according to some embodiments of the present disclosure;

FIG. 2 is a schematic flowchart of determining an input text according to some embodiments of the present disclosure;

FIG. 3A is a schematic diagram of a display interface before speech input according to some embodiments of the present disclosure;

FIG. 3B is a schematic diagram of a display interface during speech input according to some embodiments of the present disclosure;

FIG. 3C is a schematic diagram of a display interface after speech input according to some embodiments of the present disclosure;

FIG. 4 is a block diagram of a speech input apparatus according to some embodiments of the present disclosure;

FIG. 5 is a block diagram of a speech input apparatus according to some other embodiments of the present disclosure;

FIG. 6 is a block diagram of an electronic device according to some embodiments of the present disclosure.

It should be understood that for ease of description, the dimensions of the various parts shown in the drawings are not necessarily drawn to scale. Throughout the drawings, the same or similar reference numerals denote the same or similar components. Therefore, once an item is defined in one drawing, it may not be further discussed in subsequent drawings.

### DETAILED DESCRIPTION OF EMBODIMENTS

The technical solutions in the embodiments of the present disclosure are clearly and completely described below with reference to the drawings in the embodiments of the present disclosure. It should be understood that the present disclosure may be implemented in various forms, and should not be construed as limited to the embodiments set forth herein.

It should be understood that the various steps described in the method implementations of the present disclosure may be performed in different orders and/or in parallel. In addition, the method implementations may include additional steps and/or omit performing the illustrated steps. The scope of the present disclosure is not limited in this respect. Unless otherwise specified, the relative arrangements and numerical values of the components and steps set forth in these embodiments should be construed as merely exemplary, and do not limit the scope of the present disclosure.

The term “include/comprise” and its variants used in the present disclosure mean open terms that at least include the following elements/features, but do not exclude other elements/features, that is, “include/comprise but not limited to”. The term “based on” means “at least partially based on”.

It should be noted that concepts such as “first” and “second” mentioned in the present disclosure are merely used to distinguish between different apparatuses, modules, or units, and are not used to limit an order or interdependence of the functions performed by these apparatuses, modules, or units. Unless otherwise specified, concepts such as “first” and “second” are not intended to imply that the objects so described must be in a given order in terms of time, space, ranking, or in any other manner.

It should be noted that the modifications of “one” and “a plurality of” mentioned in the present disclosure are illustrative rather than restrictive, and those skilled in the art should understand that unless otherwise clearly indicated in the context, they should be construed as “one or more”.

The names of messages or information exchanged between a plurality of apparatuses in the implementations of the present disclosure are used for illustrative purposes only, and are not used to limit the scope of these messages or information.

User information (including but not limited to user device information, user personal information, etc.) and data (including but not limited to data for analysis, stored data, displayed data, etc.) involved in the present disclosure are information and data authorized by the user or fully authorized by all parties, and the collection, use, and processing of the relevant data need to comply with relevant laws, regulations, and standards of relevant countries and regions, and provide corresponding operation entrance for the user to choose authorization or rejection.

The embodiments of the present disclosure are described in detail below with reference to the drawings, but the present disclosure is not limited to these specific embodiments. The following specific embodiments may be combined with each other, and the same or similar concepts or processes may not be described in detail in some embodiments. In addition, in one or more embodiments, a particular feature, structure, or characteristic may be combined in any suitable manner that will be clear to those of ordinary skill in the art from this disclosure.

The speech input function in the related art, in a complex language environment, if there are a relatively large number of words corresponding to a pronunciation of a user, may cause recognition accuracy of content of speech input by the user not to be sufficiently high. To improve the accuracy of speech input, embodiments of the present disclosure provide a new speech input method, which is capable of combining contextual data related to a user with speech data input by the user, to determine a text corresponding to the speech data, thereby improving the accuracy of speech input.

FIG. 1 is a schematic flowchart of a speech input method according to some embodiments of the present disclosure.

As shown in FIG. 1, the speech input method includes: step S1, receiving, from an input box of a conversation between a user and an agent, speech data input by the user; and step S2, determining an input text corresponding to the speech data according to the speech data and contextual data, where the contextual data includes at least one of text data input by the user in the input box before the speech data is input, or a historical conversation between the user and the agent.

The agent may be an agent based on a large language model (LLM) or another natural language processing (NLP) model. For example, the agent may be constructed using a machine learning model such as a variational autoencoder (VAE), a convolutional neural network (CNN), or a transformer (Transformer).

The user may input the speech data by, for example, triggering a speech input control in the input box. After the user triggers the speech input control, the input box may also display a prompt identification to remind the user that speech input may be started.

The text data input by the user in the input box refers to a part of messages input through text before the user performs speech input. For example, before the user performs speech input, “My hometown is” may be input through text in the input box, and the above text input may be used as contextual data for converting the user's speech input into the input text.

The historical conversation between the user and the agent may include, for example, a history of instructions input by the user, replies made by the agent, and the like, before the user inputs a message through the input box this time. To avoid noise, the above historical conversation record may be limited to a historical conversation between the user and the agent within a certain period of time, for example, the last 30 conversations between the user and the agent may be selected, or conversations between the user and the agent within the last 2 days may be selected, as the contextual data for converting the user's speech input into the input text.

In the above speech input method, the user may input a complete message through speech, or may input a part of a message through text and then input a remaining part of the message through speech. In other words, the speech input method may also be used in scenarios such as continuation of a sentence break.

The input text corresponding to the speech data may be determined by combining the speech data input by the user with the contextual data. For example, a machine learning model may be used to determine a candidate text corresponding to the speech data input by the user. For example, the speech data input by the user is recognized as “shuĭ hú”, and it may be determined that the candidate text includes words such as “Chinese words corresponding to water kettle” , “Chinese words corresponding to Water Margin” , and “Chinese words corresponding to water splash”. In combination with the contextual data, for example, the user has already typed in “Chinese words corresponding to The Water Margin”, the user may more likely desire to input “Chinese words corresponding to Water Margin” consistent with the typed content through speech. In this case, “Chinese words corresponding to Water Margin” may be determined as the input text.

The speech input method according to the embodiments of the present disclosure is described above with reference to FIG. 1. With the above speech input method, when the user performs speech input, in the face of complex situations including, for example, homonymy, vague pronunciation, various accents, etc., the contextual data related to the user may be combined with the speech data input by the user to determine the corresponding text, thereby improving the accuracy of speech input.

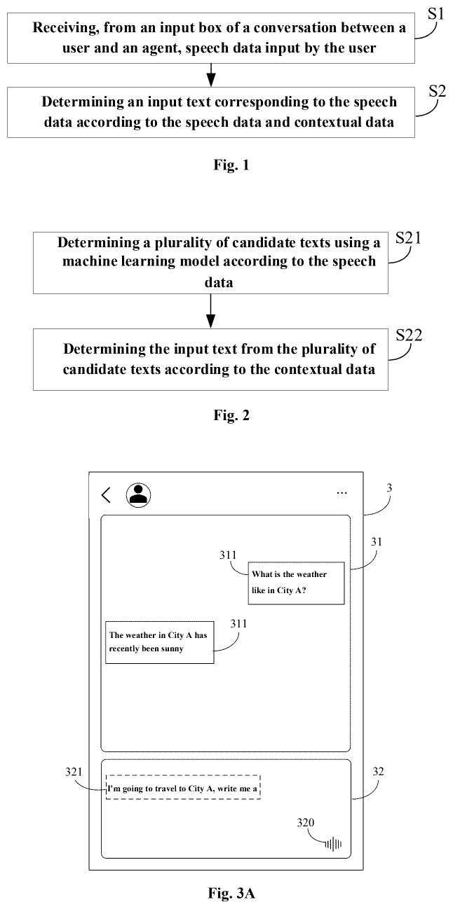

How to determine the input text corresponding to the speech data according to the speech data and the contextual data is specifically described below with reference to FIG. 2. FIG. 2 is a schematic flowchart of determining an input text according to some embodiments of the present disclosure.

As shown in FIG. 2, step S2, determining an input text corresponding to the speech data according to the speech data and contextual data may include: step S21, determining a plurality of candidate texts by using a machine learning model according to the speech data; and step S22, determining the input text from the plurality of candidate texts according to the contextual data.

In step S21, firstly, candidate texts may be determined from the speech data according to machine learning models such as an acoustic model and a language model.

The acoustic model may include, for example, a pre-trained model trained based on unlabeled speech data, and is used to convert the speech data into a preliminary text sequence.

For example, the speech data input by the user includes, for example, “tài yáng”. The acoustic model may determine, by recognizing the speech data, that the text corresponding to “tài” may be “Chinese character corresponding to very”, “Chinese character corresponding to titanium” , or similar characters such as “Chinese character corresponding to platform” and “Chinese character corresponding to lift” , and these possible texts will be used as the preliminary text sequence of “tài”. Similarly, the preliminary text sequence of “yang” may also be determined for “yáng”.

The language model may include, for example, a traditional model trained based on statistical phrase combination, and is used to optimize the preliminary text sequence and determine the candidate text.

For example, different phrases corresponding to the speech data, such as “Chinese word corresponding to sun”, “Chinese word corresponding to Tai Yang”, and “Chinese word corresponding to excessively strict”, may be obtained through different orders of the texts in the preliminary text sequence.

Then, the language model may be used to determine the probabilities of occurrence of the different phrases, and for example, a phrase with a probability exceeding a certain threshold may be used as the candidate text, or after the phrases are sorted in descending order of probability, several phrases ranking in the top order may be used as the candidate text.

For “Chinese word corresponding to sun”, “Chinese word corresponding to Tai Yang”, and “Chinese word corresponding to excessively strict” in the example, for example, according to statistical data of commonly-used phrases, it may be determined that the probability of occurrence of “Chinese word corresponding to sun” is 80%, the probability of occurrence of “Chinese word corresponding to excessively strict” is 10%, and the probability of occurrence of “Chinese word corresponding to Tai Yang” does not exceed 1%. Therefore, “Chinese word corresponding to sun” and “Chinese word corresponding to excessively strict” may be determined as the candidate text determined according to the speech data.

In step S22, an input text is determined from the plurality of candidate texts according to the contextual data.

As described above, the contextual data may include the text data input by the user in the input box and the historical conversation between the user and the agent. With the above content as a reference, in the process of determining the input text, not only a universal model is considered, but also the user's own input is considered.

The text data input by the user in the input box is, for example, a part of a complete message that the user wants to input, for example, “The earth belongs to the solar system, then”. After inputting a part of the message, the user may desire to input the rest of the message through speech. Since the text data and the speech data belong to the same complete message, the content input by the user through speech is more likely to be correlated with the text data input by the user, for example, content related to the “solar system”.

The historical conversation between the user and the agent includes, for example, a historical message input by the user and a related reply of the agent, before the user inputs the message this time. For example, before inputting the message this time, the user may be discussing a topic about “dance” with the agent, so the message input by the user this time may also be content related to dance.

Using the above contextual data to determine the user's final input text from the candidate text may reduce recognition errors and improve the accuracy of speech input.

In some embodiments, determining the input text from the plurality of candidate texts according to the contextual data includes: determining the input text from the plurality of candidate texts according to at least one of a text or a semantics of the contextual data.

In the above embodiments, determining the input text from the candidate text may be divided into three manners: determining the input text according to the text of the contextual data, determining the input text according to the semantics of the contextual data, and determining the input text by combining the text and the semantics of the contextual data. The three manners of determining the input text from the candidate text are separately described below.

In the first manner, determining the input text from the plurality of candidate texts according to at least one of a semantics or a text of the contextual data may include: determining the input text from the plurality of candidate texts according to a character matching degree between each candidate text of the plurality of candidate texts and the contextual data.

When the input text is determined according to the text, the character matching degree may be determined according to the number of repeated characters between the candidate text and the contextual data. The character matching degree may also be interpreted as a degree of text repetition., For example, in the case where the contextual data is “Chinese word corresponding to setting sun”, the character matching degree of the candidate text “Chinese word corresponding to setting sun” is higher than the character matching degree of the candidate text “Chinese word corresponding to Luo Ri” .

The input text corresponding to the speech data input by the user may be determined according to the character matching degree between each of the candidate texts and the contextual data. For example, a candidate text with the highest character matching degree may be used as the input text. In other words, a candidate text with the largest number of repeated characters with the contextual data may be used as the input text.

Determining the input text according to the text may be used for determining a proper noun, such as a name. In the case where a name appears in the contextual data and the name is input again through speech, determining the input text according to the character matching degree may more accurately determine the name corresponding to the speech data. Compared with the related art where speech input recognition is performed only based on conventional evidences such as phrase statistical data, the speech input method of the present disclosure may improve the accuracy of speech input in the face of complex situations such as proper nouns.

In the process of determining the input text according to the text of the contextual data, there may be a case where texts of a plurality of pieces of contextual data match different candidate texts. How to determine the input text in the above case is described below.

In some embodiments, in a case where the contextual data includes a plurality of historical conversations between the user and the agent, determining the input text from the plurality of candidate texts according to a character matching degree between each candidate text and the contextual data includes: determining the input text from the plurality of candidate texts according to time stamps of the plurality of historical conversations and a character matching degree between each of the candidate texts and each of the plurality of historical conversations.

In the case where there are a plurality of historical conversations in the contextual data, the input text may be further determined according to the time stamp of each historical conversation, that is, the time at which the historical conversation occurred, and the character matching degree between each candidate text and each historical conversation.

Through the time stamp of the historical conversation, the historical conversation closer to the user's speech input may be preferentially considered as a reference for determining the input text, thereby further improving the correlation between the contextual data and the user's speech input.

For example, the contextual data includes, for example, a historical conversation A and a historical conversation B between the user and the agent. The plurality of candidate texts determined according to the speech data include a candidate text A and a candidate text B, where the candidate text A is a candidate text with the highest character matching degree with the historical conversation A, and the candidate text B is a candidate text with the highest character matching degree with the historical conversation B.

In other words, a candidate text with the highest character matching degree with each historical conversation may be first determined according to the character matching degree between each candidate text and each historical conversation.

For example, the historical conversation A is, for example, “How to raise a pet”, and the historical conversation B is, for example, “How to plant potatoes”. In the case where the speech data input by the user is “yăng yú”, the candidate text includes, for example, “Chinese word corresponding to raising”, “Chinese word corresponding to potato”, and “Chinese word corresponding to fish farming”. Through the character matching degree between each candidate text and the historical conversation A and the character matching degree between each candidate text and the historical conversation B, it may be determined that “Chinese word corresponding to raising” is the candidate text A, and “Chinese word corresponding to potato” is the candidate text B.

In the case where the difference value between the character matching degree between each of the candidate texts and each of the historical conversations is less than a certain threshold, the time stamp of the historical conversation may be further considered. For example, in the above example, the character matching degree between the candidate text A and the historical conversation A is the same as the character matching degree between the candidate text B and the historical conversation B. In this case, the time stamp of the historical conversation may be further considered.

Through the time stamp of the historical conversation, it may be determined which historical conversation has a smaller time interval with the speech data input by the user. In the above example, the time stamp of the historical conversation A is, for example, 5 minutes ago, and the time stamp of the historical conversation B is, for example, 30 minutes ago, it may be determined that the time interval between the historical conversation A and the speech data input by the user is small. The historical conversation A closer to the user's speech input may be preferentially considered, as a reference for determining the input text. At this time, the candidate text A may be determined as the input text.

In the process introduced above, the difference value of the character matching degree is first determined, and in the case where the difference value is less than a certain threshold, the comparison is performed through the time stamp. In addition to the above process, it may also be first determined, through the time stamp of the historical conversation, which historical conversation has a smaller time interval with the speech data input by the user. For example, in the above example, it is determined that the historical conversation A is closer to the user's speech input.

Then, the character matching degree between each candidate text and each historical conversation may be considered, and the candidate text A and the candidate text B with the highest character matching degree with the historical conversations A and B are determined. In the case where the character matching degree A between the candidate text A and the historical conversation A is greater than or equal to the character matching degree B between the candidate text B and the historical conversation B, or the character matching degree A is less than the character matching degree B but the difference value between the character matching degree A and the character matching degree B is less than a certain threshold, the candidate text A is determined as the input text.

In the above example, the threshold of the difference value may be determined according to the time stamp of the historical conversation. In the case where the time interval between the historical conversation B and the speech data input by the user is relatively long, the probability of association between the historical conversation B and the speech data input by the user is relatively small, therefore, a higher threshold may be set, so as to further preferentially consider the historical conversation A.

In the above method, by further considering the time stamp of the historical conversation, the historical conversation with a closer time interval may be preferentially used as a reference for determining the input text, thereby improving the accuracy of speech input.

How to determine the input text according to the text of the contextual data in the case where the contextual data includes a plurality of historical conversations with different time stamps is introduced above with reference to examples. How to determine the input text according to the text of the contextual data in the case where the contextual data includes both the text data input by the user and the historical conversation data between the user and the agent is described below.

In some embodiments, determining the input text from the plurality of candidate texts according to a character matching degree between each candidate text and the contextual data includes: determining the input text from the plurality of candidate texts according to a character matching degree between each of the candidate texts and the text data and a character matching degree between each of the candidate texts and the historical conversation.

In the case where the contextual data includes both the text data input by the user and the historical conversation data between the user and the agent, since the text data and the speech data input by the user usually belong to the same message, the text data input by the user may be preferentially considered as a reference for determining the input text.

For example, the contextual data includes, for example, text data C input by the user and a historical conversation D between the user and the agent. The plurality of candidate texts determined according to the speech data include a candidate text C and a candidate text D, where the candidate text C is a candidate text with the highest character matching degree with the text data C, and the candidate text D is a candidate text with the highest character matching degree with the historical conversation D.

In other words, a candidate text with the highest character matching degree may be first determined according to the character matching degree between each candidate text and the text data D and the character matching degree between each candidate text and the historical conversation D.

For example, the text data C is, for example, “How to measure a wall”, and the historical conversation D is, for example, “What is the function of a side beam of a house”. In the case where the speech data input by the user is “cè liáng”, the candidate text includes, for example, “Chinese word corresponding to measurement”, “Chinese word corresponding to side beam”, and “Chinese word corresponding to (vehicle)”. Through the character matching degree between each candidate text and the historical conversation C and the character matching degree between each candidate text and the historical conversation D, it may be determined that “Chinese word corresponding to measurement” is the candidate text C, and “Chinese word corresponding to side beam” is the candidate text D.

In the case where the difference value between the character matching degree between each of the candidate texts and the text data and the character matching degree between each of the candidate texts and the historical conversation is less than a certain threshold, the type of the contextual data may be further considered. For example, in the above example, the character matching degree between the candidate text C and the text data C is the same as the character matching degree between the candidate text D and the historical conversation D. In this case, the type of the contextual data may be further considered.

Since the text data and the speech data input by the user usually belong to the same message, the speech data input by the user is more likely to be associated with the text data. Therefore, the text data C may be preferentially considered as a reference for determining the input text, and the candidate text C is determined as the input text.

In some embodiments, the threshold of the difference value may also be determined according to the time stamp of the historical conversation. In the case where the time interval between the historical conversation D and the speech data input by the user is relatively long, the probability of association between the historical conversation D and the speech data input by the user is relatively small, therefore, a higher threshold may be set, so as to further preferentially consider the text data C.

In the above method, by further considering the type of the contextual data, the text data input by the user may be preferentially used as a reference for determining the input text, thereby improving the accuracy of speech input.

Some example processes of determining the input text according to the text are introduced above, as one manner of determining the input text from the candidate text according to the contextual data. How to determine the input text from the candidate text according to the semantics of the contextual data in another manner of determining the input text from the candidate text is described below.

In some embodiments, determining the input text from the plurality of candidate texts according to at least one of a semantics or a text of the contextual data includes: determining the input text from the plurality of candidate texts according to a semantic matching degree between each candidate text and the contextual data.

The semantic matching degree may be determined according to whether the semantics between the candidate text and the contextual data match. For example, whether the semantics between the candidate text and the contextual data belong to the same field, whether the semantics involve similar topics, and the like.

Similar to the character matching degree, the input text corresponding to the speech data input by the user may be determined through the semantic matching degree between each candidate text and the contextual data. For example, a candidate text with the highest semantic matching degree may be used as the input text.

Determining the input text according to the semantics may be used for determining a topic. For example, before performing speech input, the user may discuss a food-related topic with the agent. When the user performs speech input, it may be determined, according to the semantics of the contextual data, that the content the user wants to input is more likely to be related to food. In the case where the candidate text includes, for example, “Chinese word corresponding to chicken nuggets” and “Chinese word corresponding to extremely fast”, it may be determined that “chicken nuggets” is the input text.

In the process of determining the input text according to the semantics of the contextual data, there may also be a case where semantics of a plurality of pieces of contextual data match different candidate texts. How to determine the input text in the above case is described below.

In some embodiments, in a case where the contextual data includes a plurality of historical conversations between the user and the agent, determining the input text from the plurality of candidate texts according to a semantic matching degree between each candidate text and the contextual data includes: determining the input text from the plurality of candidate texts according to time stamps of the plurality of historical conversations and a semantic matching degree between each of the candidate texts and each of the plurality of historical conversations.

Through the time stamp of the historical conversation, the historical conversation closer to the user's speech input may be preferentially considered as a reference for determining the input text, thereby further improving the correlation between the contextual data and the user's speech input.

For example, the contextual data includes, for example, a historical conversation E and a historical conversation F between the user and the agent. The plurality of candidate texts determined according to the speech data include a candidate text E and a candidate text F, where the candidate text E is a candidate text with the highest semantic matching degree with the historical conversation E, and the candidate text F is a candidate text with the highest semantic matching degree with the historical conversation.

In other words, a candidate text with the highest semantic matching degree with each historical conversation may be first determined according to the semantic matching degree between each candidate text and each historical conversation.

For example, the historical conversation E is, for example, a conversation about a children's playground, and the historical conversation F is, for example, a conversation about smell. In the case where the speech data input by the user is “qù wèi”, the candidate text includes, for example, “Chinese word corresponding to interest”, “Chinese word corresponding to odor removal”, “Chinese word corresponding to go and ask”, and the like. Through the semantic matching degree between each candidate text and the historical conversation E and the semantic matching degree between each candidate text and the historical conversation F, it may be determined that “Chinese word corresponding to interest” is the candidate text E, and “Chinese word corresponding to odor removal” is the candidate text F.

In the case where the difference value between the semantic matching degree between each of the candidate texts and each of the historical conversations is less than a certain threshold, the time stamp of the historical conversation may be further considered. For example, in the above example, the semantic matching degree between the candidate text E and the historical conversation E is basically the same as the semantic matching degree between the candidate text F and the historical conversation F. In this case, the time stamp of the historical conversation may be further considered.

Through the time stamp of the historical conversation, it may be determined which historical conversation has a smaller time interval with the speech data input by the user. In the above example, the time stamp of the historical conversation E is, for example, 5 minutes ago, and the time stamp of the historical conversation F is, for example, 30 minutes ago. It may be determined that the time interval between the historical conversation E and the speech data input by the user is small. The historical conversation E closer to the user's speech input may be preferentially considered, as a reference for determining the input text, and at this time, the candidate text E is determined as the input text.

In some embodiments, the threshold of the difference value may be determined according to the time stamp of the historical conversation. In the case where the time interval between the historical conversation F and the speech data input by the user is relatively long, the probability of association between the historical conversation F and the speech data input by the user is relatively small, therefore, a higher threshold may be set, so as to further preferentially consider the historical conversation E.

In the above method, by further considering the time stamp of the historical conversation, the historical conversation with a closer time interval may be preferentially used as a reference for determining the input text, thereby improving the accuracy of speech input.

How to determine the input text according to the semantics of the contextual data in the case where the contextual data includes a plurality of historical conversations with different time stamps is introduced above with reference to examples. How to determine the input text according to the semantics of the contextual data in the case where the contextual data includes both the text data input by the user and the historical conversation data between the user and the agent is described below.

In some embodiments, determining the input text from the plurality of candidate texts according to a semantic matching degree between each candidate text and the contextual data includes: determining the input text from the plurality of candidate texts according to a semantic matching degree between each of the candidate texts and the text data and a semantic matching degree between each of the candidate texts and the historical conversation.

In the case where the contextual data includes both the text data input by the user and the historical conversation data between the user and the agent, since the text data and the speech data input by the user usually belong to the same message, the text data input by the user may be preferentially considered as a reference for determining the input text.

For example, the contextual data includes, for example, text data G input by the user and a historical conversation H between the user and the agent. The plurality of candidate texts determined according to the speech data include a candidate text G and a candidate text H, where the candidate text G is a candidate text with the highest semantic matching degree with the text data G, and the candidate text H is a candidate text with the highest semantic matching degree with the historical conversation H.

In other words, a candidate text with the highest semantic matching degree may be first determined according to the semantic matching degree between each candidate text and the text data G and the semantic matching degree between each candidate text and the historical conversation H.

For example, the text data G is, for example, a text about tourism, and the historical conversation H is, for example, a conversation about personality. In the case where the speech data input by the user is “chéng shì”, the candidate text includes, for example, “Chinese word corresponding to city”, “Chinese word corresponding to honest”, “Chinese word corresponding to program”, and the like. Through the semantic matching degree between each candidate text and the historical conversation G and the semantic matching degree between each candidate text and the historical conversation H, it may be determined that “Chinese word corresponding to city” is the candidate text G, and “Chinese word corresponding to honest” is the candidate text H.

In the case where the difference value between the semantic matching degree between each of the candidate texts and the text data and the semantic matching degree between each of the candidate texts and the historical conversation is less than a certain threshold, the type of the contextual data may be further considered. For example, in the above example, the semantic matching degree between the candidate text G and the input text G is basically the same as the semantic matching degree between the candidate text H and the historical conversation H. In this case, the type of the contextual data may be further considered.

Since the text data and the speech data input by the user usually belong to the same message, the speech data input by the user is more likely to be associated with the text data. Therefore, the text data G may be preferentially considered as a reference for determining the input text. At this time, the candidate text G is determined as the input text.

In some embodiments, the threshold of the difference value may also be determined according to the time stamp of the historical conversation. In the case where the time interval between the historical conversation H and the speech data input by the user is relatively long, the probability of association between the historical conversation H and the speech data input by the user is relatively small, therefore, a higher threshold may be set, so as to further preferentially consider the input text G.

In the above method, by further considering the type of the contextual data, the text data input by the user may be preferentially used as a reference for determining the input text, thereby improving the accuracy of speech input.

How to determine the input text from the candidate text according to the text of the contextual data and the semantics of the contextual data separately is introduced above. How to determine the input text from the candidate text by combining the text and the semantics of the contextual data is described below.

In some embodiments, determining the input text from the plurality of candidate texts according to at least one of a text or a semantics of the contextual data includes: in response to there being a candidate text with a character matching degree with the contextual data higher than a threshold in the plurality of candidate texts, determining the input text from the plurality of candidate texts according to a character matching degree between each candidate text and the contextual data; and in response to there being no candidate text with a character matching degree with the contextual data higher than the threshold in the plurality of candidate texts, determining the input text from the plurality of candidate texts according to a semantic matching degree between each candidate text and the contextual data.

In other words, since the character matching degree is a direct match between the candidate text and the contextual data, and the semantic matching degree is an indirect match between the candidate text and the contextual data, in the process of recognizing the speech data input by the user, the character matching degree may be preferentially considered, and then the semantic matching degree is considered.

In the above embodiments, the character matching degree between each candidate text and the contextual data may be first determined and compared with a preset threshold, such as 80% matching degree. In the case where there is a candidate text whose character matching degree with the contextual data exceeds the threshold, the input text may be determined from these candidate texts according to the character matching degree.

In the case where there is no candidate text whose character matching degree with the contextual data exceeds the threshold, it represents that there is no text in the contextual data directly associated with the input speech data. At this time, the semantic matching degree between each candidate text and the contextual data may continue to be used to determine the input text from the candidate texts.

The specific process of determining the input text from the candidate text according to the character matching degree or the semantic matching degree may be the same or similar to the process described in the above embodiments, and details are not repeated here.

Through the above steps, the text and the semantics of the contextual data may be combined to determine the input text from the candidate text, further improving the accuracy of speech input.

In other embodiments, a matching score of each candidate text may be determined according to the character matching degree and the semantic matching degree between each candidate text and the contextual data, and the input text may be determined from the candidate texts according to the matching score.

In other words, for example, the character matching degree and the semantic matching degree may be combined in a weighting manner to determine the input text from the candidate texts. In the weighting process, a higher weight may also be assigned to the character matching degree, so as to improve the importance of the character matching degree, thereby improving the accuracy of speech input.

Various embodiments of how to determine the input text according to the speech data and the contextual data are introduced above with reference to FIG. 2. The above speech input method is capable of combining the contextual data related to the user with the speech data input by the user to determine the corresponding text, thereby improving the accuracy of speech input.

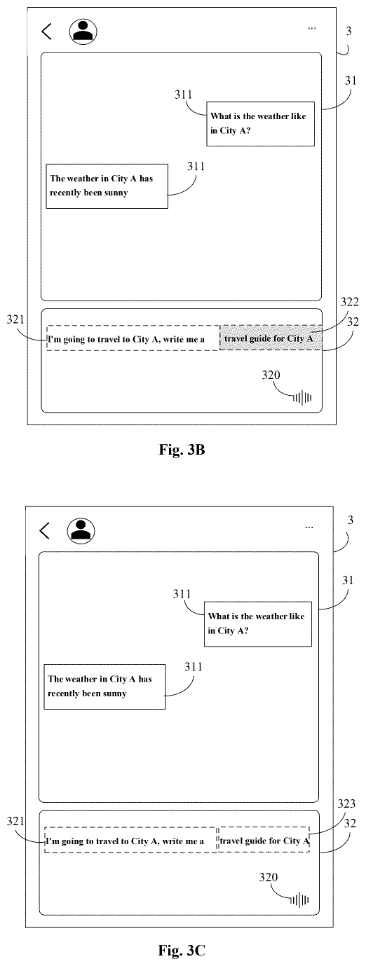

Next, examples of display interfaces in the speech input process are introduced with reference to FIG. 3A to FIG. 3C.

FIG. 3A is a schematic diagram of a display interface before speech input according to some embodiments of the present disclosure. As shown in FIG. 3A, the display interface 3 may include a display area 31 and an input box 32. The display interface 3 is, for example, a conversation interface between a user and an agent.

The display area 31 may include a historical conversation record 311 between the user and the agent, for example, “What is the weather like in City A?” input by the user and “The weather in City A has recently been sunny” replied by the agent in FIG. 3A.

The input box 32 may include a speech input control 320 and text data 321 input by the user through text.

In some embodiments, receiving, from an input box of a conversation between a user and an agent, speech data input by the user includes: after the user inputs text data in the input box, receiving the speech data input by the user in response to the user triggering a speech input control in the input box, where the text data and the speech data belong to a same message input by the user.

In the embodiment shown in FIG. 3A, the text data 321 input by the user in the input box through text is “I'm going to travel to City A, write me a”, and after the user inputs the text, the speech input control 320 may be triggered to perform speech input. The speech data input by the user is, for example, speech corresponding to “a travel guide for City A”.

The speech data input by the user through speech and the text data input by the user through text may belong to the same message, in other words, the user may implement functions such as sentence breaking and continuation through speech input.

FIG. 3B is a schematic diagram of a display interface during speech input according to some embodiments of the present disclosure.

As shown in FIG. 3B, after receiving the user's speech input but before determining the input text, an intermediate text 322 may be displayed in the input box, in a first format, where the intermediate text 322 is determined by a machine learning model according to the speech data.

The intermediate text 322 may be, for example, a text with the highest probability of occurrence in the candidate texts determined through the acoustic model and the language model as described above, such as “a tourism highway in City A” as shown in FIG. 3B. The first format for displaying the intermediate text 322 is, for example, text display with gray fill, through the first display manner, the user may be prompted that the text displayed in the input box is the intermediate text, not the final determined input text.

FIG. 3C is a schematic diagram of a display interface after speech input according to some embodiments of the present disclosure.

As shown in FIG. 3C, after the input text is determined, the input text 323 may be displayed in the input box in a second format, where the second format is different from the first format.

After the input text is determined, as shown in FIG. 3C, “a travel guide for City A”, the determined input text 323 may be displayed in a different format, for example, the second format is text display without gray fill. Through the switching of the display format, the user may be reminded that the input text has been determined. The second format for displaying the determined input text 323 may be the same as the format for displaying the text data input by the user.

It should be noted that the above formats for displaying the intermediate text and the input text are only exemplary, rather than restrictive, for example, the intermediate text and the input text may be displayed in different font colors to achieve the above distinction.

In some embodiments, determining an input text corresponding to the speech data according to the speech data and contextual data includes: verifying the intermediate text according to at least one of a text or semantics of the contextual data, and determining the verified intermediate text as the input text.

In addition to determining the input text from the candidate text according to the contextual data as introduced above, the determined intermediate text may also be verified through the contextual data, thereby determining the input text.

For example, in the case where the character matching degree between the intermediate text and the contextual data exceeds a certain threshold, it may be directly determined that the verification is passed, and the intermediate text is used as the input text.

In the case where the character matching degree between the intermediate text and the contextual data is relatively low, the semantic matching degree between the intermediate text and the contextual data may be further determined, and the intermediate text may be verified by whether the semantics match.

In some embodiments, the speech data input first by the user may also be verified by the speech data input later by the user. For example, in the case where the user inputs two sentences by speech, the first sentence may be verified by the semantics of the second sentence, further avoiding speech input errors and improving the accuracy of speech input.

Through the speech input method introduced above with reference to FIG. 3A to FIG. 3C, the input process may be displayed for the user during the speech input process, improving user experience.

The above is the speech input method provided by the embodiments of the present disclosure. The above speech input method of the present disclosure is capable of combining the contextual data related to the user with the speech data input by the user to determine the corresponding text, thereby improving the accuracy of speech input.

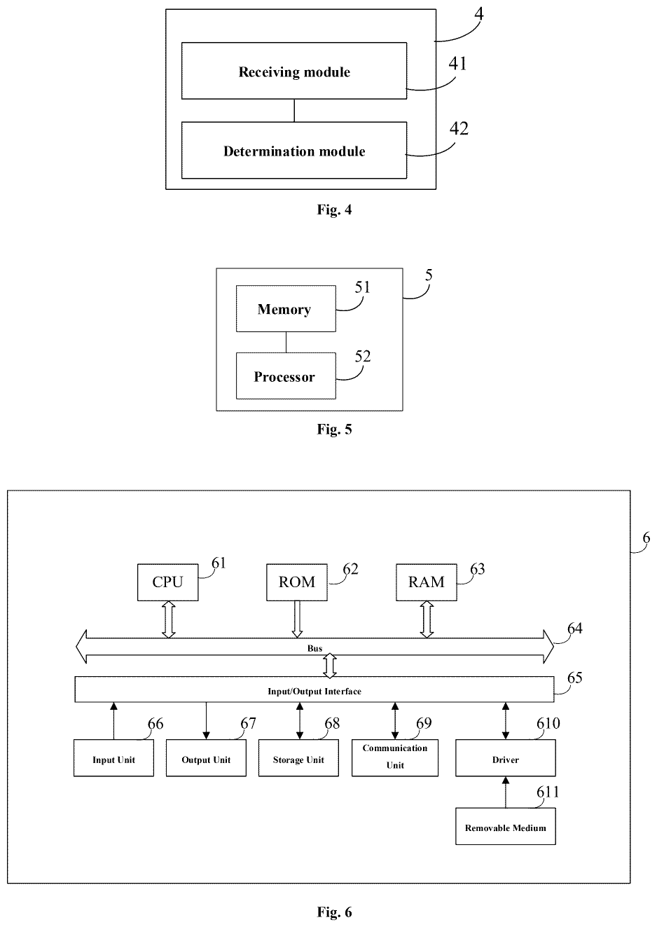

A speech input apparatus according to embodiments of the present disclosure is described below with reference to FIG. 4 and FIG. 5, which is configured to perform any one of the above speech input methods. FIG. 4 is a block diagram of a speech input apparatus according to some embodiments of the present disclosure.

As shown in FIG. 4, the speech input apparatus 4 includes: a receiving module 41, configured to receive, from an input box of a conversation between a user and an agent, speech data input by the user; and a determination module 42, configured to determine a target input text corresponding to the speech data according to the speech data and contextual information data of the user, as an input of the user, where the contextual data includes at least one of: text data input by the user in the input box before the speech data is input, or a historical conversation between the user and the agent.

The receiving module 41 of the speech input apparatus 4 may be configured to perform, for example, step S1 in FIG. 1. The determination module 42 of the speech input apparatus 4 may be configured to perform, for example, step S2 in FIG. 1.

The above speech input apparatus of the present disclosure is capable of combining the contextual data related to the user with the speech data input by the user to determine the corresponding text, thereby improving the accuracy of speech input.

FIG. 5 is a block diagram of a speech input apparatus according to some other embodiments of the present disclosure.

As shown in FIG. 5, the speech input apparatus 5 includes: at least one memory 51; and at least one processor 52 coupled to the at least one memory 51, the at least one processor 52 configured to, based on instructions stored in the at least one memory 51, execute the speech input method according to any one of the above embodiments.

The memory 51 is used to store one or more computer-readable instructions. The memory 51 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. The memory 111 may store, for example, an operating system, an application, a boot loader, a database, and other programs, and may also store various applications, various data, and the like.

The processor 52 is used to run the computer-readable instructions to implement the speech input method according to any one of the above embodiments. For the specific implementation of each step of the method, reference may be made to the above embodiments, such as the steps in FIG. 1, and details of the same parts are not repeated herein.

The above speech input apparatus of the present disclosure is capable of combining the contextual data related to the user with the speech data input by the user to determine the corresponding text, thereby improving the accuracy of speech input.

The processor 52 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 52 and the memory 51 may directly or indirectly communicate with each other. For example, the processor 52 and the memory 51 may communicate through a network. The network may include a wireless network, a wired network, and/or any combination of a wireless network and a wired network. The processor 52 and the memory 51 may also communicate with each other through a system bus, which is not limited in the present disclosure.

It should be noted that the components of the speech input apparatus 5 shown in FIG. 5 are only exemplary, rather than restrictive, and the speech input apparatus 5 may have other components according to actual application needs. The processor 52 may control other components in the speech input apparatus 5 to perform desired functions.

The speech input apparatus 5 may be implemented by software, firmware, and/or hardware, and may be integrated in an apparatus in which a related application is installed.

FIG. 6 is a block diagram of an electronic device according to some embodiments of the present disclosure.

The electronic device 6 shown in FIG. 6 may be a computer system having a dedicated hardware structure, and when a related application is installed, the electronic device 6 may perform corresponding functions.

The electronic device includes, but is not limited to, a mobile terminal such as a smartphone, a notebook computer, a personal digital assistant (PDA), a tablet personal computer (Tablet PC), a portable media player (PMP), a vehicle-mounted terminal (such as a vehicle navigation terminal), and a wearable device, and a stationary terminal such as a digital television and a desktop computer.

As shown in FIG. 6, a central processing unit (CPU) 61 executes various processes according to a program stored in a read-only memory (ROM) 62 or a program loaded from a storage unit 68 into a random access memory (RAM) 63. The RAM 63 stores data required when the CPU 61 executes various processes and the like, as needed. The central processing unit is merely exemplary, and it may be another type of processor, such as the various processors described above. The ROM 62, the RAM 63, and the storage unit 68 may be various forms of computer-readable storage media. It should be noted that although the ROM 62, the RAM 63, and the storage unit 68 are shown separately in FIG. 6, one or more of them may be combined or located in the same or different memories or storage modules.

The CPU 61, the ROM 62, and the RAM 63 are connected to each other via a bus 64. An input/output interface 65 is also connected to the bus 64.

The following components are connected to the input/output interface 65: an input unit 66 such as a touch screen, a touchpad, a keyboard, a mouse, an image sensor, a microphone, an accelerometer, and a gyroscope; an output unit 67 including a display such as a cathode ray tube (CRT) and a liquid crystal display (LCD), a speaker, a vibrator, and the like; the storage unit 68 including a hard disk, a magnetic tape, and the like; and a communication unit 69 including a network interface card such as a LAN card and a modem. The communication unit 69 allows communication processing to be performed via a network such as the Internet. It is easily understood that although the components in the electronic device 6 are shown to communicate through the bus 64 in FIG. 6, they may also communicate through a network or other means, where the network may include a wireless network, a wired network, and/or any combination of a wireless network and a wired network.

If necessary, a driver 610 is also connected to the input/output interface 65. A removable medium 611 such as a magnetic disk, an optical disc, a magneto-optical disc, and a semiconductor memory is mounted on the driver 610 as needed, so that a computer program read therefrom is installed into the storage unit 68 as needed.

In the case where the above series of processes are implemented by software, a program that constitutes the software may be installed from a network such as the Internet or a storage medium such as the removable medium 611.

According to the embodiments of the present disclosure, the process described above with reference to the flowchart may be implemented as a computer software program. For example, some embodiments of the present disclosure include a computer program product, which, when running on a computer, causes the computer to implement the speech input method according to any one of the above embodiments. The computer program product includes computer instructions carried on a computer-readable medium, and includes program code for performing the method shown in the flowchart. In such an embodiment, the computer instructions may be downloaded and installed from a network through the communication unit 69, or installed from the storage unit 68, or installed from the ROM 62. When the computer program is executed by the CPU 61, the speech input method of the embodiments of the present disclosure is executed.

The above speech input method, is capable of combining the contextual data related to the user with the speech data input by the user to determine the corresponding text, thereby improving the accuracy of speech input.

It should be noted that in the context of the present disclosure, the computer-readable medium may be a tangible medium that may contain or store a program for use by or in combination with an instruction execution system, apparatus, or device.

The computer-readable medium may be a computer-readable storage medium, a computer-readable signal medium, or any combination thereof.

The computer-readable storage medium includes but is not limited to an electrical, magnetic, optical, electromagnetic, infrared, or semiconductor system, apparatus, or device, or any combination thereof. More specific examples of the computer-readable storage medium may include but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. The computer-readable storage medium has computer instructions stored thereon, and when the instructions are executed by a processor, the speech input method according to any one of the above embodiments is implemented.

The above speech input method of the present disclosure, is capable of combining the contextual data related to the user with the speech data input by the user to determine the corresponding text, thereby improving the accuracy of speech input.

The computer-readable signal medium may include a data signal propagated on a baseband or as a part of a carrier, and computer-readable program code is carried therein. The data signal propagated in this manner may be in various forms, and includes but is not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including but not limited to: a wire, an optical cable, a radio frequency (RF), etc., or any suitable combination thereof.

The above computer-readable medium may be included in the above electronic device, or may exist alone without being assembled into the electronic device.

In some embodiments, a computer program is further provided, including: instructions that, when executed by a processor, cause the processor to execute the speech input method according to any one of the above embodiments. For example, the instructions may be embodied as computer program code.

In the embodiments of the present disclosure, the computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected to the user computer through any kind of network (including a local area network (LAN) or a wide area network (WAN)), or may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be performed at least partly by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and the like.

Although some specific embodiments of the present disclosure have been described in detail by way of examples, those skilled in the art should understand that the above examples are only for illustration, rather than limiting the scope of the present disclosure. Those skilled in the art should understand that the above embodiments may be modified without departing from the scope and spirit of the present disclosure. The scope of the present disclosure is defined by the appended claims.

What is claimed is

1. A speech input method, comprising:
receiving, from an input box of a conversation between a user and an agent, speech data input by the user; and
determining an input text corresponding to the speech data according to the speech data and contextual data, wherein the contextual data comprises at least one of text data input by the user in the input box before the speech data is input, or a historical conversation between the user and the agent.

2. The speech input method of claim 1, wherein determining the input text corresponding to the speech data according to the speech data and the contextual data comprises:
determining a plurality of candidate texts using a machine learning model according to the speech data; and
determining the input text from the plurality of candidate texts according to the contextual data.

3. The speech input method of claim 2, wherein determining the input text from the plurality of candidate texts according to the contextual data comprises:
determining the input text from the plurality of candidate texts according to at least one of a text or a semantics of the contextual data.

4. The speech input method of claim 3, wherein determining the input text from the plurality of candidate texts according to at least one of a semantics or a text of the contextual data comprises:
determining the input text from the plurality of candidate texts according to a character matching degree between each candidate text of the plurality of candidate texts and the contextual data.

5. The speech input method of claim 4, wherein the contextual data comprises a plurality of historical conversations between the user and the agent, and determining the input text from the plurality of candidate texts according to the character matching degree between each candidate text of the plurality of candidate texts and the contextual data, comprises:
determining the input text from the plurality of candidate texts according to time stamps of the plurality of historical conversations and the character matching degree between each candidate text of the plurality of candidate texts and the plurality of historical conversations.

6. The speech input method of claim 4, wherein the contextual data comprises text data input by the user in the input box and a historical conversation between the user and the agent, and determining the input text from the plurality of candidate texts according to the character matching degree between each candidate text of the plurality of candidate texts and the contextual data comprises:
determining the input text from the plurality of candidate texts according to the character matching degree between each candidate text of the plurality of candidate texts and the text data and a character matching degree between each candidate text of the plurality of candidate texts and the historical conversation.

7. The speech input method of claim 3, wherein determining the input text from the plurality of candidate texts according to at least one of a semantics or a text of the contextual data comprises:
determining the input text from the plurality of candidate texts according to a semantic matching degree between each candidate text of the plurality of candidate texts and the contextual data.

8. The speech input method of claim 7, wherein the contextual data comprises a plurality of historical conversations between the user and the agent, and determining the input text from the plurality of candidate texts according to the semantic matching degree between each candidate text of the plurality of candidate texts and the contextual data comprises:
determining the input text from the plurality of candidate texts according to time stamps of the plurality of historical conversations and a semantic matching degree between each candidate text of the plurality of candidate texts and the plurality of historical conversations.

9. The speech input method of claim 7, wherein the contextual data comprises text data input by the user in the input box and a historical conversation between the user and the agent, and determining the input text from the plurality of candidate texts according to the semantic matching degree between each candidate text of the plurality of candidate texts and the contextual data comprises:
determining the input text from the plurality of candidate texts according to a semantic matching degree between each candidate text of the plurality of candidate texts and the text data and a semantic matching degree between each candidate text of the plurality of candidate texts and the historical conversation.

10. The speech input method of claim 3, wherein determining the input text from the plurality of candidate texts according to at least one of the text or the semantics of the contextual data comprises:
determining the input text from the plurality of candidate texts according to a character matching degree between each candidate text of the plurality of candidate texts and the contextual data in response to there being a candidate text with a character matching degree with the contextual data higher than a threshold in the plurality of candidate texts; or
determining the input text from the plurality of candidate texts according to a semantic matching degree between each candidate text of the plurality of candidate texts and the contextual data in response to there being no candidate text with a character matching degree with the contextual data higher than the threshold in the plurality of candidate texts.

11. The speech input method of claim 1, further comprising:
displaying an intermediate text in the input box in a first format before the input text is determined, wherein the intermediate text is determined by a machine learning model according to the speech data; and
displaying the input text in the input box in a second format after the input text is determined, wherein the second format is different from the first format.

12. The speech input method of claim 11, wherein determining the input text corresponding to the speech data according to the speech data and the contextual data comprises:
verifying the intermediate text according to at least one of text or semantics of the contextual data; and
determining the verified intermediate text as the input text.

13. The speech input method of claim 1, wherein receiving, from the input box of the conversation between the user and the agent, the speech data input by the user comprises:
receiving the speech data input by the user after the user inputs text data in the input box, in response to the user triggering a speech input control of the input box, wherein the text data and the speech data belong to a same message input by the user.

14. A speech input apparatus, comprising:
at least one memory; and
at least one processor coupled to the at least one memory, the at least one processor configured to, based on instructions stored in the at least one memory, execute a speech input method, comprising:
receiving, from an input box of a conversation between a user and an agent, speech data input by the user; and
determining an input text corresponding to the speech data according to the speech data and contextual data, wherein the contextual data comprises at least one of text data input by the user in the input box before the speech data is input, or a historical conversation between the user and the agent.

15. The speech input apparatus of claim 14, wherein determining the input text corresponding to the speech data according to the speech data and the contextual data comprises:
determining a plurality of candidate texts using a machine learning model according to the speech data; and
determining the input text from the plurality of candidate texts according to the contextual data.

16. The speech input apparatus of claim 15, wherein determining the input text from the plurality of candidate texts according to the contextual data comprises:
determining the input text from the plurality of candidate texts according to at least one of a text or a semantics of the contextual data.

17. The speech input apparatus of claim 16, wherein determining the input text from the plurality of candidate texts according to at least one of a semantics or a text of the contextual data comprises:
determining the input text from the plurality of candidate texts according to a character matching degree between each candidate text of the plurality of candidate texts and the contextual data.

18. A non-transitory computer-readable storage medium, having computer instructions stored thereon, wherein when the instructions are executed by a processor, implement a speech input method, comprising:
receiving, from an input box of a conversation between a user and an agent, speech data input by the user; and
determining an input text corresponding to the speech data according to the speech data and contextual data, wherein the contextual data comprises at least one of text data input by the user in the input box before the speech data is input, or a historical conversation between the user and the agent.

19. The non-transitory computer-readable storage medium of claim 18, wherein determining the input text corresponding to the speech data according to the speech data and the contextual data comprises:
determining a plurality of candidate texts using a machine learning model according to the speech data; and
determining the input text from the plurality of candidate texts according to the contextual data.

20. The non-transitory computer-readable storage medium of claim 19, wherein determining the input text from the plurality of candidate texts according to the contextual data comprises:
determining the input text from the plurality of candidate texts according to at least one of a text or a semantics of the contextual data.
